(19) United States
(12) Patent Application Publication
(10) Pub. No.: US 2001/0011215 A1
(43) Pub. Date: Aug. 2, 2001

(54) NETWORK DEVICE SIMULATION SYSTEM AND METHOD

(76) Inventors: SCOTT A. BEEKER, COLORADO SPRINGS, CO (US); CORNELIUS J. FALVEY, CASTLE ROCK, CO (US); MARK P. MULLALLY, LA JUNTA, CO (US)

Correspondence Address: MR. PAUL ROBERTS, MCI WORLDCOM, 1133 19TH STREET NW (9854/003), WASHINGTON, DC, 20036, US

(21) Appl. No.: 09/143,957

(22) Filed: Aug. 31, 1998

(51) Int. Cl. G06F 9/455

(52) U.S. Cl. 703/27

(57) ABSTRACT

A network device simulation system (40) has a device message emulator (42). A data source (44) is connected to the device message emulator (42). A protocol translator (44) is connected to the device message emulator (42) and outputs a protocol data unit in one of a plurality of specified protocols.

### RELATED APPLICATIONS

The present application is related to patent applications Ser. Nos. ______ (COS-96-033, COS-96-034 & COS-96-036) assigned to the same assignee as the present application and having the same inventors as the present application.

### FIELD OF THE INVENTION

The present invention relates generally to the field of networks and more particularly to a network device simulation system and method.

### BACKGROUND OF THE INVENTION

Computer systems running complex interrelated software modules require testing as new revisions of the software modules are introduced and as problems or “bugs” are discovered in existing software modules. An example of such a computer system is shown in FIG. 1. This example shows a small part of a telephone network 20. In this figure, a public telephone 22 is connected to a central office - service switching point (CO/SSP) 24. The CO/SSP 24 as part of its call processing sends a call record over a signaling network 26 to a service control point (SCP) 28. The SCP 28 passes the call records on to a fraud detection system 30. When a new version of the fraud detection system 30 has been developed, it is necessary to test the new version of the fraud detection system 30 before adding it to the telephone network. This requires simulating the flow of call records that the new version of the fraud detection system has been designed to analyze. Ideally, this simulation data would be generated by the actual network elements in a laboratory setting. Often, this is not practical due to a number of reasons, including, limited funds, limited laboratory resources, staggered development cycles of dependent network elements, etc.

Test tools are often used to generate test data when the actual network elements are not available. The test tools are used to emulate the communication interface between network elements. A typical test tool is built in such a way that it can only emulate a specific version of a single network device. As networks evolve, the communication interface between network elements changes. When this happens, conventional test tools need to be rewritten to emulate the new communication interface. In the fast evolving world of computer networks, communication interface structures change often and test tools are constantly being rewritten. Constant rewrites are time consuming and expensive.

Thus there exists a need for a network device simulation system that is not tied to a fixed communication interface structure, is inexpensive and can efficiently generate the required communication interface structure.

### SUMMARY OF THE INVENTION

A network device simulation system that overcomes these and other problems has a device message emulator. A data source is connected to the device message emulator. A protocol translator is connected to the device message emulator and outputs a protocol data unit in one of a plurality of specified protocols.

The system using the device message emulator allows a user to emulate a number of network models. These models include: client server models, peer to peer models, publish subscribe models and others. The protocol translator converts the generic commands of the device message emulator to messages specific to the specified protocol. The system is capable of transmitting data. This allows the user to quickly and inexpensively design a scenario to emulate a system component. The system is flexible and can be adapted to emulate almost any network device.

The present invention is applicable to any industry that develops inter-related software modules, including: communication companies, business and operating software companies, networking companies, defense companies, semiconductor companies, etc. Programmers need to test how their programs will work with other programs before releasing their software. This requires emulating how programs communicate with each other. For instance, if a user is testing server software the invention allows a user to quickly and easily accommodate the type of communications interface for a client server model. In addition, the invention can communicate using a variety protocols. This greatly simplifies the effort required by programmers to test their programs.

### BRIEF DESCRIPTION OF THE DRAWINGS

FIG. 1 is a block diagram of a portion of a telephone system;

FIG. 2 is a block diagram of a network device simulation system in accordance with one embodiment of the invention;

FIG. 3 is a schematic diagram of a network device simulation system in accordance with one embodiment of the invention;

FIG. 4 is a flow chart of the steps used in operating a network device simulation system in accordance with one embodiment of the invention;

FIG. 5 is an example of a communication emulation module script in accordance with one embodiment of the invention;

FIGS. 6 & 7 comprise a table of the commands used in an emulation language in accordance with one embodiment of the invention;

FIG. 8 is a table of the parameters used with the commands in the emulation language in accordance with one embodiment of the invention; and

FIG. 9 is a number of examples of the transmission statistics that are determined by the network device simulation system in accordance with one embodiment of the invention.

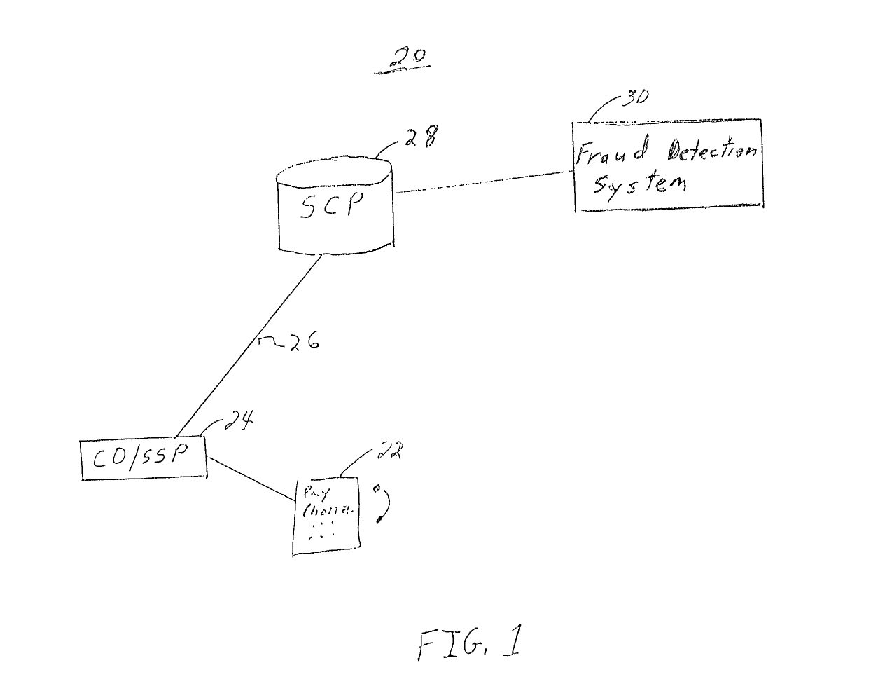

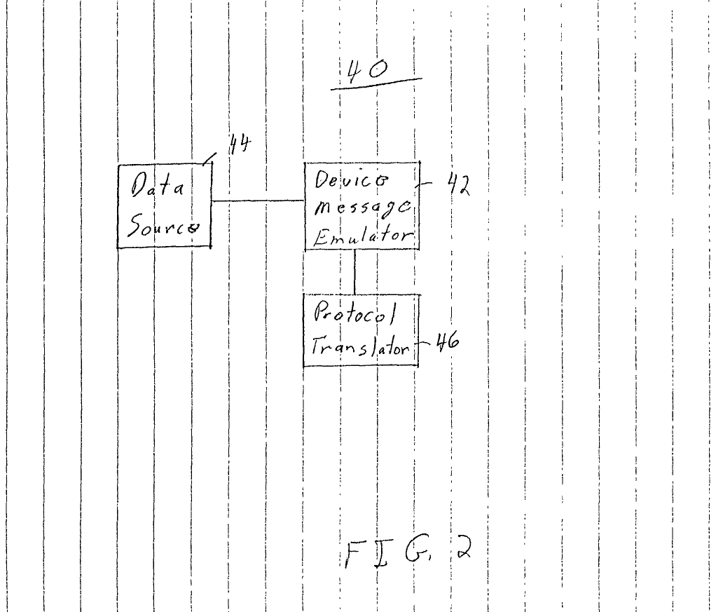

### DETAILED DESCRIPTION OF THE DRAWINGS

The invention is used in testing software modules. Particularly software modules used in networks. In order to test a software module, the programmer has to create test data. Then the programmer has to create a module to simulate the communication interface between the software module under test and the other software modules in the network. The invention is designed to provide a tool that can be easily tailored to emulate any communication interface.

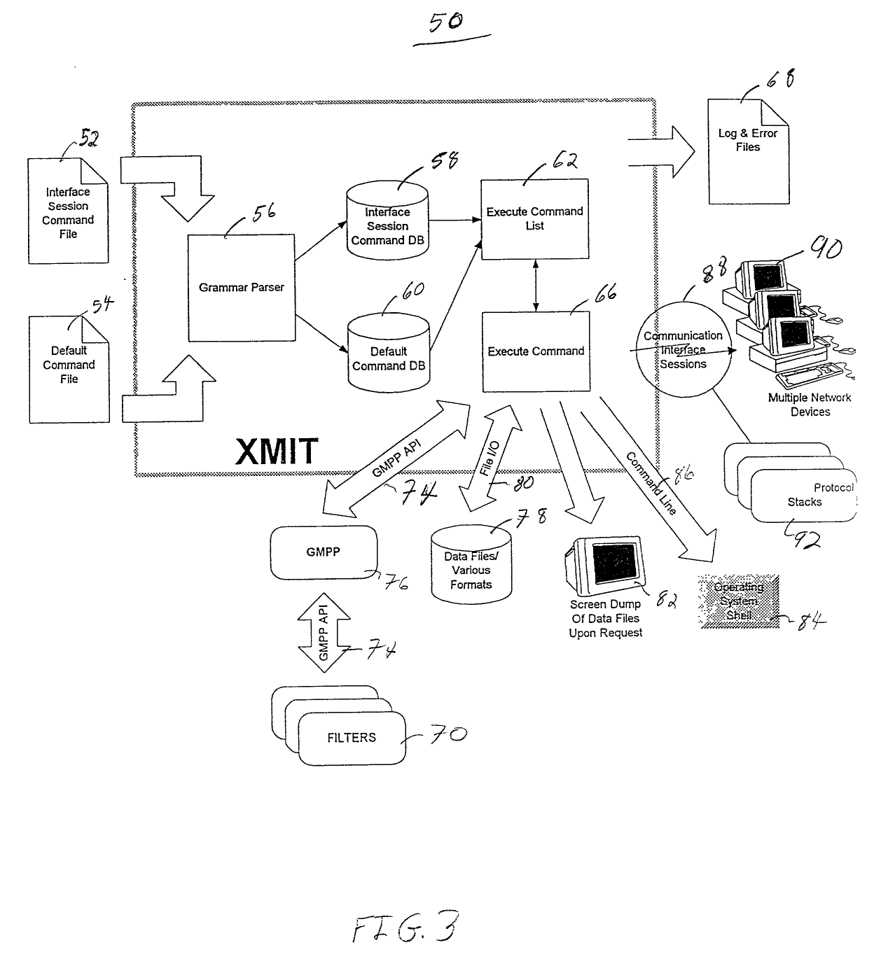

FIG. 2 is a block diagram of a network device simulation system 40 in accordance with one embodiment of the invention. A device message emulator 42 emulates the communication interface structure (communication interface) of the network device being emulated. The device message emulator 42 is coupled to a data source 44. The data source 44 in one embodiment is a file in a store. In another embodiment the data source can be another network component. In another embodiment the data is created by another test tool. A protocol translator 46 is connected to the device message emulator 42. The protocol emulator 46 converts commands and data from the device message emulator into protocol data units (e.g., packets, frames, etc.) in one of a plurality of specified protocols. The protocol data units are then transmitted to a component under test.

In one embodiment the device message emulator includes a processor (execution system) and an emulation program capable of being executed by the processor. The emulation program uses an emulation language (network communication language) that includes a number of commands. A register command directs the system to emulate the function of a server by registering a service. An accept command directs the system to inform the network that the system is ready to accept connection requests by clients. A connect command directs the system to emulate a client by requesting access to a service. A send command directs the system to send data across the network. A receive command directs the system to receive data across the network. A disconnect command directs the system to terminate a connection between the server and the client. An unregister command directs a server to eliminate a service from the network. The emulation also includes a group of conditional commands, that may be used to create complex communication interface structures. These commands may also be used to emulate other network communication models, such as peer to peer models, publish subscribe models and others.

The protocol translator 42 may translate the commands and data from the device message emulator 44 into protocol data units for a plurality of specified protocols. The protocols include, but are not limited to, RS232, RS422, TCP/IP, SNA, UDP, DECnet®, Local IPC, and Simple File.

The network device simulation system 40 may be implemented in any standard computer or may be built as a stand alone device. The component under test may be a remotely located device on the network or can be a software module running on the same computer as the network device simulation system 40.

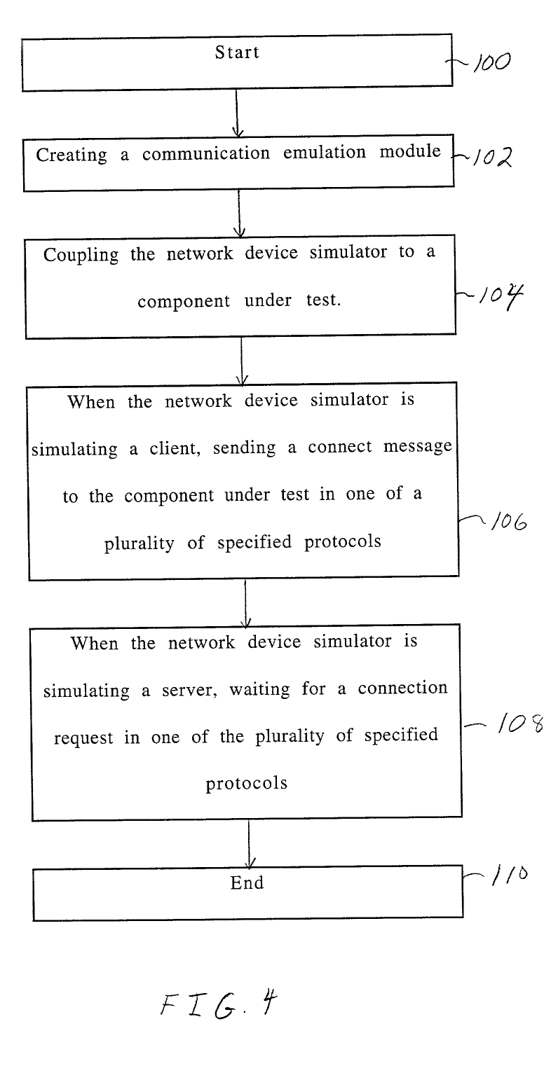

FIG. 3 is a schematic diagram of a network device simulation system (XMIT) 50 in accordance with one embodiment of the invention. An interface session command file 52 and default command file 54 are parsed by a grammar parser 56. The grammar parser 56 uses the interface session command file to build a command file that is stored in the interface session command database 58. Similarly, the grammar parser 56 uses the default command file 54 to form default commands that are stored in the default command database 60. The execute command list routine 62 processes complex commands, such as FOR, IF and other conditional commands containing logically associated sub-command lists. Informational messages and error messages from the grammar parser 56, the executed command list routine 62 and the execute command routine 66 are stored in a log file 68 and an error file 68. The execute command routine 66 executes the commands that have been built by the grammar parser 56 and the execute command list routine 62. The commands may specify filter invocation 70. The filters 70 are accessed through a generic message preprocessor (GMPP) 72 application program interface (API) 74. Other commands specify sending data from a data source 78 and the execute command routine 66 has a file input-output 80 connection to these data sources. In addition, data received from a component under test is stored in the data store 78. A command may specify that various pieces of information be displayed, so the execute command routine 66 is connected to a display device 82. A command may specify execution of instructions in an operating shell 84 through a command line 86. A communication network interface session 88 established by an emulation program is governed by the specified protocol stack. The communication network interface allows the execute command routines 66 to communicate with one or more network devices 90. Each of these network devices 90 may use a different protocol for communication. Thus protocol stacks 92 are used to make any communications between the network devices 90 and the execute command routine compliant with the specified protocol.

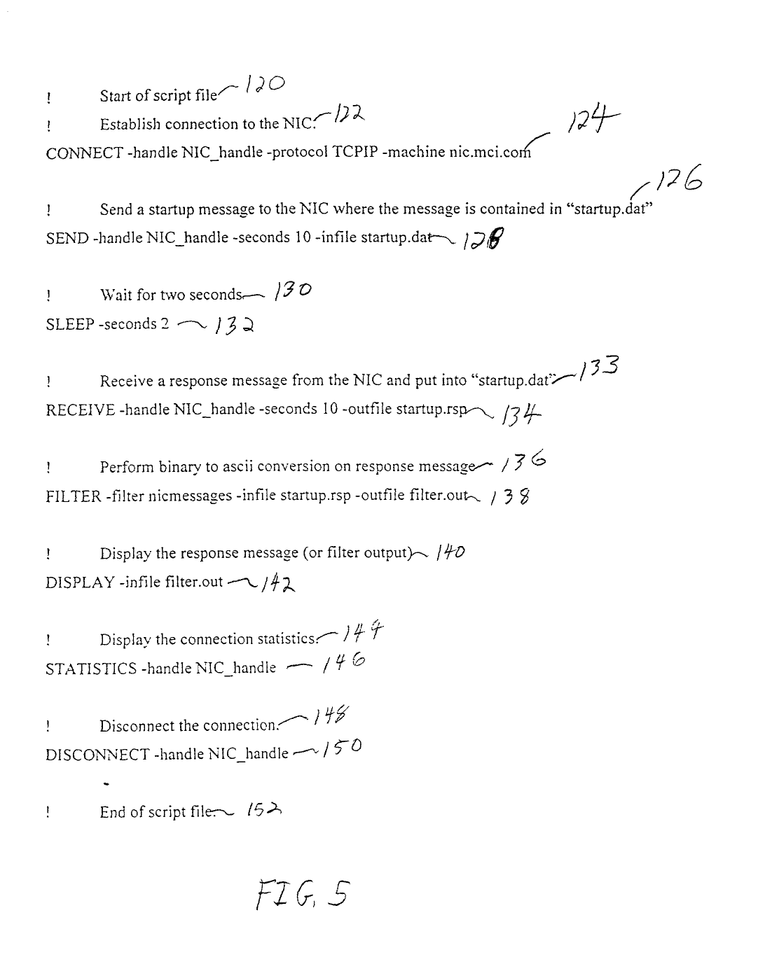

FIG. 4 is a flow chart of the steps used in operating a network device simulation system in accordance with one embodiment of the invention. The process starts, step 100, by creating a communication emulation module at step 102. The network device simulator is coupled to a component under test at step 104. When the network device simulator is simulating a client, a connect message is sent to the component under test in one of a plurality of specified protocols at step 106. When, at step 108, the network device simulator is simulating a server, the simulator waits for a connection requests in one of the plurality of specified protocols which ends the process at step 110.

In one embodiment, the communication emulation module requires creating an emulation program using an emulation language. In another embodiment, the step of sending a connect message includes specifying a protocol and a handle.

In another embodiment, the simulator executes a register command when simulating a server. The simulator then executes an accept command that notifies clients that the server is ready to accept connect commands. When the simulator is withdrawing a server service it executes an unregister command.

In one embodiment, the emulation language includes a send command to transmit a datum (or file) to the component under test. The emulation language also includes a receive command to receive a datum (file) from the component under test.

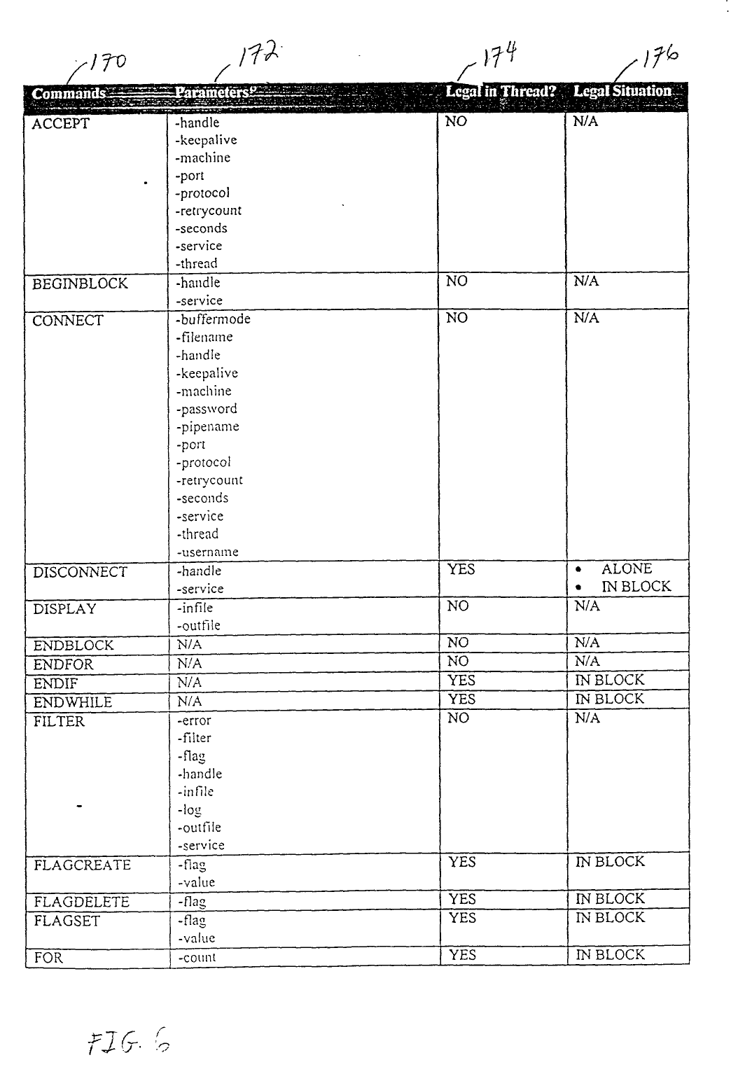

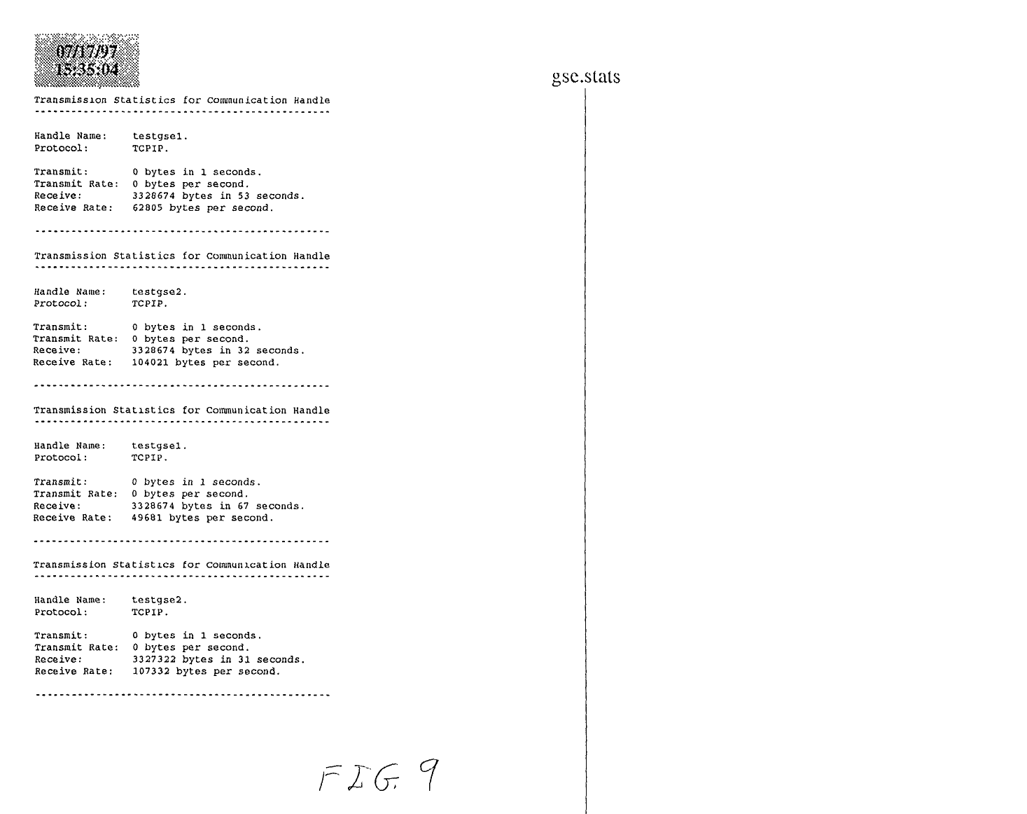

FIG. 5 is an example of a communication emulation module script in accordance with one embodiment of the invention. The lines beginning with ! are comment lines. The first line 120 states that this is the start of the script file. Line 122 states that the following command establishes a connection to a device called a NIC (network information concentrator). Line 124 shows a connect command. Line 126 explains that a startup message is being sent to the NIC. Line 128 is a send command. Line 130 states that the program then waits for two seconds. Line 132 is a sleep command. Line 133 explains that the following command requires the simulator to receive a response message from the NIC. Line 134 is a receive command. Line 136 explains that a binary to ASCII conversion is performed on the response message. Line 138 is a filter command that calls the GMPP to execute a specific filter. Line 140 explains that the response message is to be displayed. Line 142 is a display command. Line 144 explains that the next command displays connection statistics. An example of the connection statistics is shown in FIG. 9. Line 146 shows a statistics command. Line 148 states that the following command is a disconnect command. Line 150 is a disconnect command. Line 152 explains that this is the end of the script file. This is a very simple example of a script file but it shows how a communication interface structure is emulated using the emulation language of the present invention.

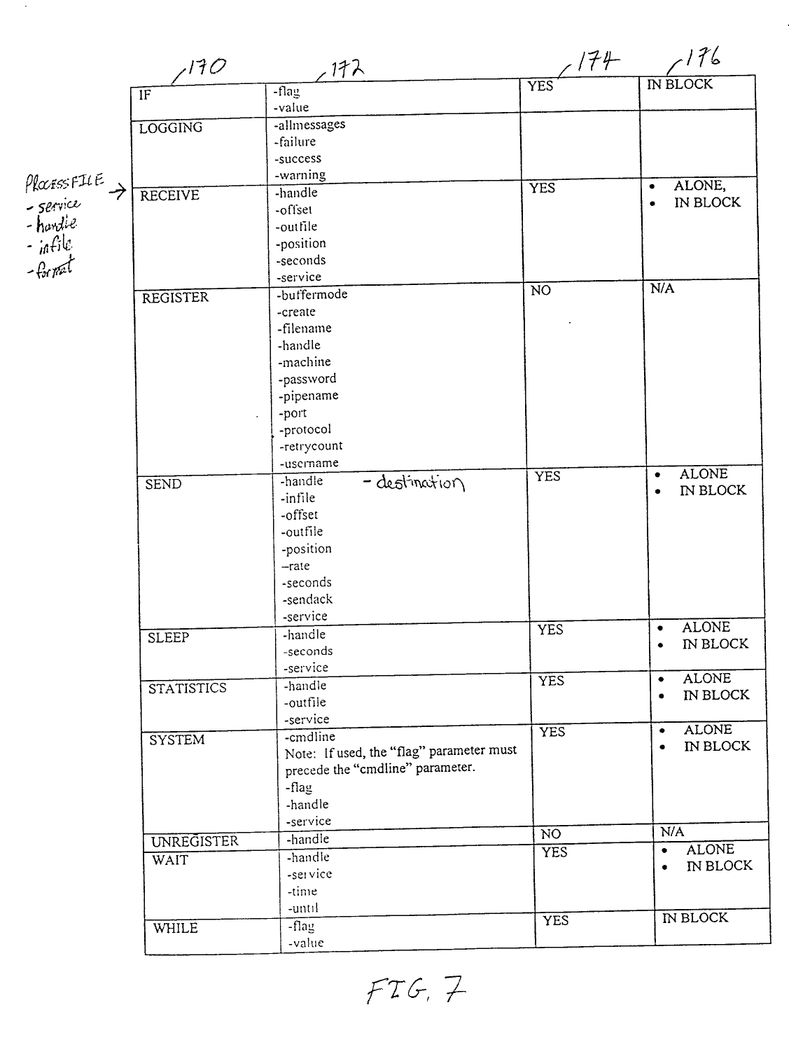

FIGS. 6 & 7 comprise a table of the commands used in an emulation language in accordance with one embodiment of the invention. The commands column 170 shows a plurality of commands used in defining an emulation module. The parameters column 172 shows the parameters that may be specified with the command. For instance, the CONNECT command has a handle parameter that identifies the device and port to which a connection is desired. The CONNECT command also has a protocol parameter that defines the protocol for the communication session. The third column 174 explains whether the command may be used in a thread. The simulator is a multi-threaded application, but not all commands may be used in a thread. The final column 176 defines when the command may be used.

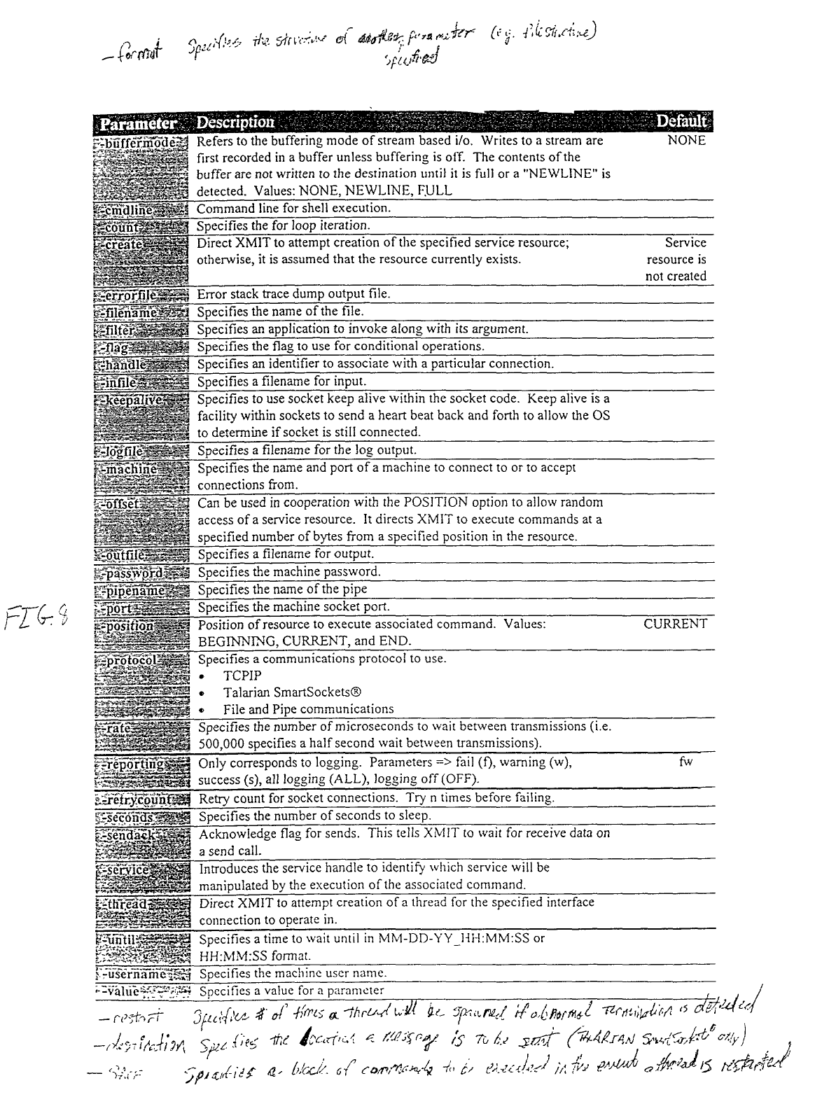

FIG. 8 is a table of the parameters used with the commands in the emulation language in accordance with one embodiment of the invention. The table explains each of the parameters.

Using the invention described above a user can quickly configure the test tool to emulate any communication interface structure. The test tool is easily modified for new revisions, thus saving the user time and money.

The methods described herein mayπ be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A network device simulation system comprising:
a device message emulator;
a data source connected to the device message emulator; and
a protocol translator connected to the device message emulator that outputs a protocol data unit in one of a plurality of specified protocols.

2. The network device simulation system of claim 1, wherein the device message emulator comprises:
a processor; and
an emulation program capable of being executed by the processor.

3. The network device simulation system of claim 2, wherein the emulation program uses an emulation language that includes a command to accept a request for connection from a component under test.

4. The network device simulation system of claim 2, wherein the emulation program uses an emulation language that includes a command to request a connection to a component under test.

5. The network device simulation system of claim 4, wherein the command to request the connection includes a parameter specifying a protocol for the connection.

6. The network device simulation system of claim 2, wherein the emulation program uses an emulation language that includes a command to register a service of the network device simulation system.

7. The network device simulation system of claim 6, wherein the emulation program uses the emulation language that includes a command to unregister the service of the network device simulation system.

8. The network device simulation system of claim 2, wherein the emulation program uses an emulation language that includes a command to disconnect from a component under test.

9. The network device simulation system of claim 2, wherein the emulation program uses an emulation language that includes a command to send a datum from the data source to a component under test.

10. The network device simulation system of claim 2, wherein the emulation program uses an emulation language that includes a command to receive a datum from a component under test.

11. The network device simulation system of claim 2, wherein the emulation program uses an emulation language that includes a group of conditional commands.

12. The network device simulation system of claim 1, wherein the protocol translator is capable of emulating TCP/IP.

13. The network device simulation system of claim 1, wherein the device message emulator is capable of emulating a client server model.

14. The network device simulation system of claim 1, wherein the device message emulator is capable of emulating a peer to peer model.

15. The network device simulation system of claim 1, wherein the device message emulator is capable of emulating a publish subscribe model.

16. The network device simulation system of claim 1, wherein the protocol emulator is capable of emulating a system network architecture.

17. The network device simulation system of claim 1, further including a default command file accessible by the device message emulator.

18. A method of operating a network device simulator, comprising the steps of:
(a) creating a communication emulation module;
(b) coupling the network device simulator to a component under test;
(c) when the network device simulator is simulating a client, sending a connect message to the component under test in one of a plurality of specified protocols; and
(d) when the network device simulator is simulating a server, waiting for a connection request in one of the plurality of specified protocols.

19. The method of claim 18, wherein step (a) further includes the step of:
(a1) creating an emulation program using an emulation language.

20. The method of claim 18, wherein the step of sending the connect message includes specifying a protocol.

21. The method of claim 18, wherein the step of sending the connect message further includes specifying a handle.

22. The method of claim 18, wherein step (d) further includes the step of:
(d1) executing a register command.

23. The method of claim 22, further including the step of:
(d2) executing an accept command.

24. The method of claim 23, further including the step of:
(d3) executing an unregistered command.

25. The method of claim 18, further includes the step of:
(d1) executing a send command to transmit a datum to the component under test.

26. The method of claim 25, wherein a protocol translator formats the datum in a specified communication protocol before transmission to the component under test.

27. The method of claim 25, further including the step of:
(d2) executing a receive command to receive a datum from the component under test.

28. The method of claim 27, further including the step of:
(d3) storing the datum;
(d4) performing a filter operation on the datum.

29. The method of claim 28, wherein the filter operation converts the datum from a first data format to a second data format.

30. The method of claim 28, further including the step of:
(d5) executing a disconnect command.

31. A programming language for simulating a network device, comprising:
a network communication language to emulate a communication interface between a network device and a component under test, the network communication language including a plurality of commands; and
an execution system capable of executing the plurality of commands.

32. The programming language of claim 31, wherein the programming language allows a user to specify a default command file.

33. The programming language of claim 31, wherein the network communication language implements a send command to transmit a datum.

34. The programming language of claim 31, wherein the network communication language implements a filter command.

35. The programming language of claim 31, wherein the programming language allows a user to specify a log file to which the execution system writes a plurality of informational messages.

36. The programming language of claim 31, wherein the network communication language allows a user to specify a data file for holding data received from the component under test.

37. The programming language of claim 31, wherein the programming language allows a user to specify an error file to which the execution system writes an error message.

38. The programming language of claim 31, wherein the plurality of commands includes a connect command to request a connection to the component under test.

39. The programming language of claim 38, wherein the connect command includes a protocol parameter that defines the protocol to be used for the connection to the component under test.

40. The programming language of claim 38, wherein the connect command includes a handle.

41. The programming language of claim 38, wherein the plurality of commands includes a disconnect command, that disconnects the connection to the component under test.

42. The programming language of claim 31, wherein the plurality of commands includes a register command that registers a service of a server.

43. The programming language of claim 42, wherein the register command includes a protocol parameter that defines the protocol to be used for a connection to the component under test.

44. The programming language of claim 42, wherein the register command includes a handle.

45. The programming language of claim 42, wherein the plurality of commands includes an unregistered command that unregisters the service of the server.

46. The programming language of claim 31, wherein the plurality of commands includes a group of conditional commands.

47. The programming language of claim 31, wherein the network communication language is multithreaded.
